(19) United States
(12) Patent Application Publication
(10) Pub. No.: US 2002/0167539 A1
(43) Pub. Date: Nov. 14, 2002

(54) Portal server enabling joint exploration of the internet with an expert

(75) Inventors: Michael Wayne Brown, Georgetown, TX (US); Rabindranath Dutta, Austin, TX (US); Michael A. Paolini, Austin, TX (US)

Correspondence Address: Duke W. Yee, Carstens, Yee & Choon, LLP, P.O. Box 802334, Dallas, TX, 75380, US

(73) Assignee: International Business Machines Corporation, Armonk, NY (US)

(21) Appl. No.: 09/844,394

(22) Filed: Apr. 27, 2001

(51) Int. Cl. G06F 3/00; G06F 13/00

(52) U.S. Cl. 345/705

(57) ABSTRACT

A method, system and computer readable instructions for obtaining assistance in a search for information concerning a subject area, on a data processing system, is provided. An interactive expertise session is requested. The request for the interactive expertise session is received from a live help selection option located on a browser graphical user interface. Responsive to the request for the interactive expertise session, a communication interface and an electronic page are received which are related to the subject area. Generated interactive expertise is displayed. The generated interactive expertise is simultaneously displayed upon both the communication interface and the electronic page.

### BACKGROUND OF THE INVENTION

1. Technical Field

The present invention relates generally to an improved data processing system and, in particular, to a method, system, and computer program for searching for and locating relevant data. Still more particularly, the present invention relates to a method, system, and computer program for searching for and locating relevant data with the aid of an expert.

2. Description of Related Art

The Internet, also referred to as an “internetwork”, is a set of computer networks, possibly dissimilar, joined together by means of gateways that handle data transfer and the conversion of messages from the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transactions using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

With respect to commerce on the Web, individual consumers and business use the Web to purchase various goods and services. In offering goods and services, some companies offer goods and services solely on the Web while others use the Web to extend their reach.

Presently, time is a precious commodity for many people. Faced with time constraints due to holding a full time job, family, extracurricular activities and leisure time, people often have a difficult time allocating enough time to exploring the Web to gather information which may affect one's everyday life. Compounding this problem is the vast array of information available on the Web. Unless a person knows a specific web address to access, many hours can be expended searching for information. In addition, Web sites are often confusing and contain misleading information. Even after the investment of such time, often one ends up with volumes of irrelevant and unneeded information resulting in a fruitless search and the wasting of a considerable amount of time.

For example, suppose a person desires to purchase additional memory for a home computer. Due to the vast array of computer equipment vendors located on the Internet, by the person simply typing in “memory” in an attempt to search the Internet, several thousand web sites may be displayed matching this term. Sifting through all of these Internet sites would be an exercise in futility and consume a large amount of time. Furthermore, even if the proper memory chip is found on the Internet, a purchaser may not know if that particular memory chip will fit his or her machine. Typically, in the offline world this is not a problem because in a store which sells such computer equipment, there is usually someone who works at the store that can be asked for help or there is some type of documentation describing what memory chip is proper for what specific computer. However, in the online world such help is not available. A prospective purchaser of the memory chip must choose the memory chip without any available assistance.

Therefore, it would be advantageous to have an improved method, system, and computer instructions for searching the Internet employing the aid of an expert.

### SUMMARY OF THE INVENTION

The present invention provides a method, system and computer readable instructions for obtaining assistance in a search for information concerning a subject area, on a data processing system. An interactive expertise session is requested. The request for the interactive expertise session is received from a live help selection option located on a browser graphical user interface. Responsive to the request for the interactive expertise session, a communication interface and an electronic page are received which are related to the subject area. Generated interactive expertise is displayed. The generated interactive expertise is simultaneously displayed upon both the communication interface and the electronic page.

Furthermore, the present invention provides a method, system and computer readable instructions for assigning an expert for assisting in a search for information on a data processing system. The expert is registered with a web server on the data processing system. Characteristics of the registered expert are provided, wherein the characteristics of the registered expert are stored in a database. The registered expert is then located to provide assistance in the search for information based on the stored characteristics.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented;

FIG. 2 is a block diagram of a data processing system in accordance with a preferred embodiment of the present invention;

FIG. 3 is a block diagram of a data processing system shown in which the present invention may be implemented;

FIG. 4 is an exemplary block diagram of a browser program in accordance with a preferred embodiment of the present invention;

FIG. 5 is an exemplary block diagram illustrating expert web servers and a client accessing a network in accordance with a preferred embodiment of the present invention;

FIG. 6 is an exemplary flowchart illustrating an expert web server providing a means for the client accessing desired information on the network in accordance with a preferred embodiment of the present invention;

FIG. 7 is an exemplary expert availability database in accordance with a preferred embodiment of the present invention;

FIGS. 8A and 8B are an exemplary client selection processes for selecting an expert in accordance with a preferred embodiment of the present invention;

FIG. 9 is an exemplary graphical user interface for requesting and communicating with an expert in accordance with a preferred embodiment of the present invention;

FIG. 10 is an exemplary client browser and expert browser for simultaneously accessing a web page in accordance with a preferred embodiment of the present invention; and

FIG. 11 is an exemplary flowchart for a portal server enabling joint exploration of the Internet between a user and an expert in accordance with a preferred embodiment of the present invention.

### DETAILED DESCRIPTION OF THE PREFERRED EMBODIMENT

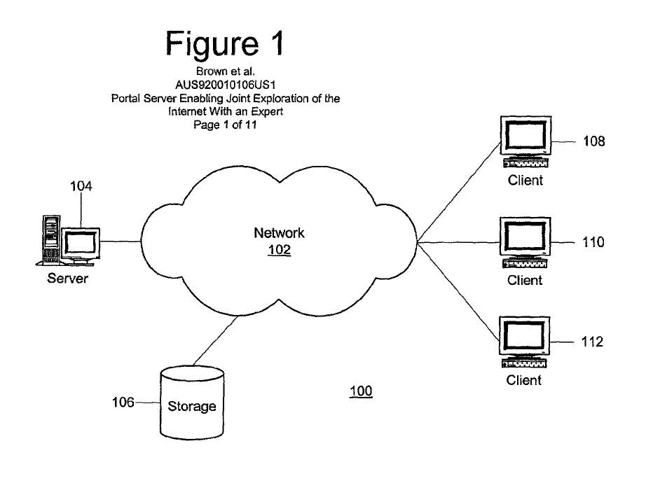

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110 and 112 also are connected to network 102. These clients 108, 110, and 112 may be, for example, personal computers or network computers. In the depicted example, server 104 provides data, such as boot files, operating system images, and applications to clients 108, 110, and 112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

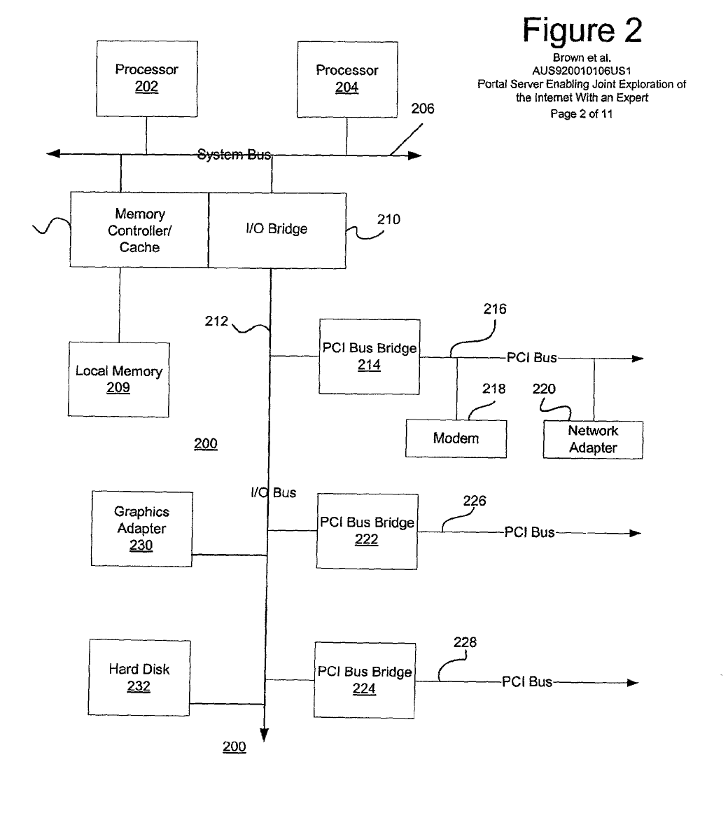

FIG. 2 is a block diagram of a data processing system in accordance with a preferred embodiment of the present invention. FIG. 2 is an example of a server, such as, for example, server 104 in FIG. 1. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218 and 220 may be connected to PCI bus 216. Typical PCI bus implementations will support four PCI expansion slots or add-in connectors. Communication links to network computers 108, 110, and 112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drive and the like also may be used in addition or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

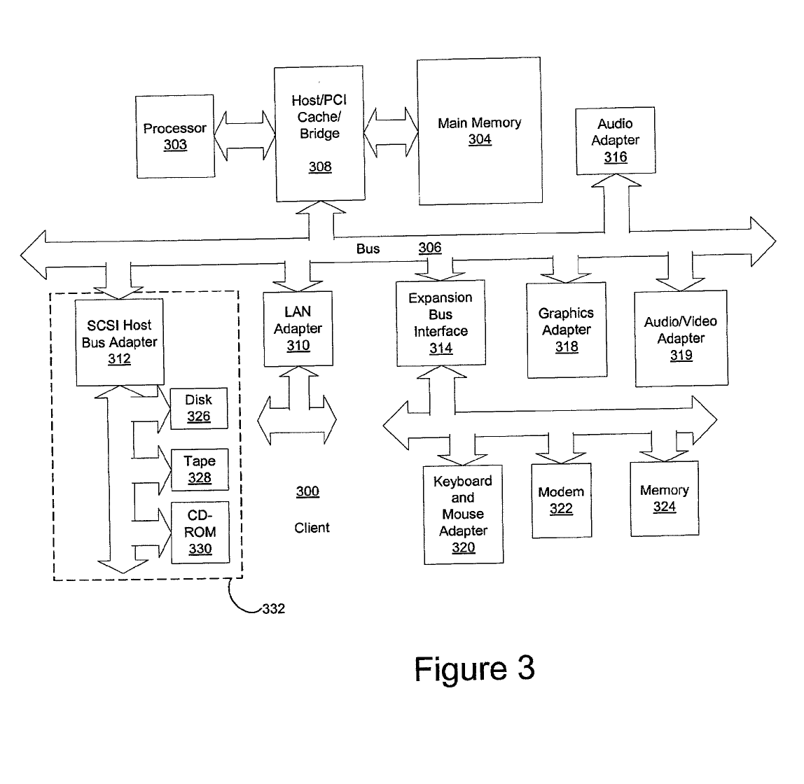

FIG. 3 is a block diagram of a data processing system shown in which the present invention may be implemented. Data processing system 300 is an example of a client computer, such as, for example, client computers 108, 110 and 112 in FIG. 1. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, small computer system interface SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system such as Windows 2000, which is available from Microsoft Corporation. An object oriented programming system such as Java may run in conjunction with the operating system and provides calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

For example, data processing system 300, if optionally configured as a network computer, may not include SCSI host bus adapter 312, hard disk drive 326, tape drive 328, and CD-ROM 330, as noted by dotted line 332 in FIG. 3 denoting optional inclusion. In that case, the computer, to be properly called a client computer, must include some type of network communication interface, such as LAN adapter 310, modem 322, or the like. As another example, data processing system 300 may be a stand-alone system configured to be bootable without relying on some type of network communication interface, whether or not data processing system 300 comprises some type of network communication interface. As a further example, data processing system 300 may be a personal digital assistant (PDA), which is configured with ROM and/or flash ROM to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The processes of the present invention are performed by processor 302 using computer implemented instructions, which may be located in a memory such as, for example, main memory 304, memory 324, or in one or more peripheral devices 326, 328, and 330.

The present invention provides a method, apparatus, and computer instructions for simplifying the process for searching the Internet for information. The mechanism of the present invention allows the user to employ an expert in a particular field and jointly search for relevant information with the expert. Areas such as shopping for homes, shopping for land, examining medical or academic information, and the like may be provided by the expert in each field. The user may register the service of an expert in various fields via the Internet. The user may request an expert with a live help selection, displayed, for example, on a graphical user interface. The user's current display may be displayed on the expert's display, thereby aiding the expert in assisting the user during the joint search session or interactive expertise session. The information available to both the user and the expert may be displayed by way of a graphical user interface. During the joint search session, the user and the expert may communicate with each other by a variety of means, such as, for example, electronic mail, an instant message messaging service, and the like.

In return for assisting the user, the expert may be compensated by charging the user. The user may be charged, for example, on a flat fee basis, a per minute basis, or a commission basis or by providing micropayments to the advisor. A micropayment may be made by several users employing the assistance of the expert at the same time. By using the mircopayment option and splitting the expert's fees among several users, the user's may be able to employ the expert at a minimal cost.

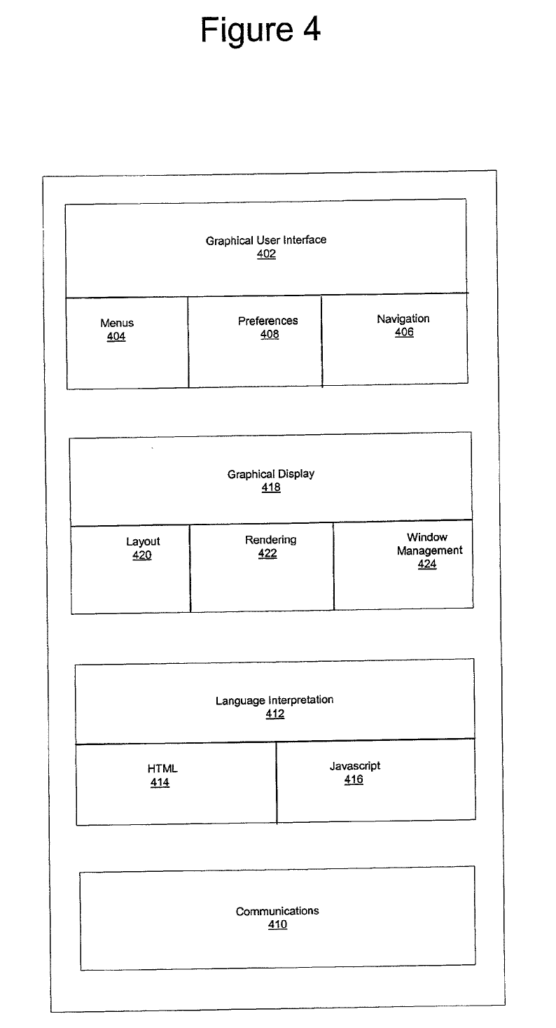

FIG. 4 is an exemplary block diagram of a browser program in accordance with a preferred embodiment of the present invention. A browser is an application used to navigate or view information or data in a distributed database, such as the Internet or the World Wide Web.

In this example, browser 400 includes a user interface 402, which is a graphical user interface (GUI) that allows the user to interface or communicate with browser 400. This interface provides for selection of various functions through menus 404 and allows for navigation through navigation 406. For example, menu 404 may allow a user to perform various functions, such as saving a file, opening a new window, displaying a history, and entering a URL. Navigation 406 allows for a user to navigate various pages and to select Web sites for viewing. For example, navigation 406 may allow a user to see a previous page or a subsequent page relative to the present page. Preferences such as those illustrated in FIG. 4 may be set through preferences 408.

Communications 410 is the mechanism with which browser 400 receives documents and other resources from a network such as the Internet. Further, communications 410 is used to send or upload documents and resources onto a network. In the depicted example, communications 410 uses HTTP. Other protocols may be used depending on the implementation. Documents that are received by browser 400 are processed by language interpretation 412, which includes an HTML unit 414 and a JavaScript unit 416. Language interpretation 412 will process a document for presentation on graphical display 418. In particular, HTML statements are processed by HTML unit 414 for presentation while JavaScript statements are processed by JavaScript unit 416.

Graphical display 418 includes layout unit 420, rendering unit 422, and window management 424. These units are involved in presenting Web pages to a user based on results from language interpretation 412.

Browser 400 is presented as an example of a browser program in which the present invention may be embodied. Browser 400 is not meant to imply architectural limitations to the present invention. Presently available browsers may include additional functions not shown or may omit functions shown in browser 400. A browser may be any application that is used to search for and display content on a distributed data processing system. Browser 400 may be implemented using known browser applications, such as Netscape Navigator or Microsoft Internet Explorer. Netscape Navigator is available from Netscape Communications Corporation while Microsoft Internet Explorer is available from Microsoft Corporation.

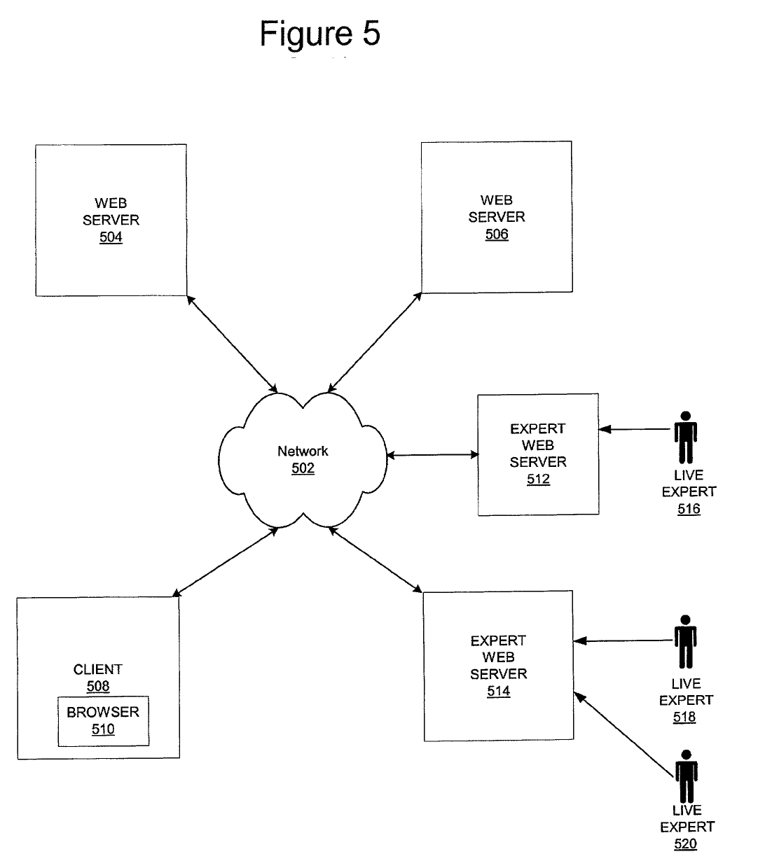

FIG. 5 is an exemplary block diagram illustrating expert web servers and a client accessing a network in accordance with a preferred embodiment of the present invention. Any number of experts and/or expert web servers may be employed at one time by a user in an effort to more effectively search and retrieve relevant information on the Internet. For example, a user may employ two experts to search for information regarding a certain area in an effort to gain as much information as possible on the area in a reduced time frame. As a further example, a user may use two experts to search for information in an effort to get an instantaneous “second opinion” with one of the experts verifying or discrediting the information the other expert has obtained.

In this example, network 502 may be linked to web server 504 and 506. In addition network 502 is also linked to client 508 and expert web servers 512 and 514. Live experts 516, 518, and 520 are located at expert web server 512 and expert web server 514 as shown in FIG. 5. Each client web server may have associated with the client a plurality of experts. Client 508 also includes browser 510 in this example. Browser 510 may be similar to browser 400 illustrated in FIG. 4.

Client 508 may first contact expert web server 512 and/or 514. Expert web servers 512 and/or 514 assists client 508 to locate information within web servers 504 and/or 506. In one embodiment, client 508 accesses network 502 and requests expert assistance from either expert web server 512 or web server 514. In an alternate embodiment, expert assistance may be requested from both web server 512 and web server 514. Multiple experts may simultaneously provide assistance from web server 512 or 514.

In this example, client 508 requests expert assistance from network 502. At the initiation of the request from client 508, using for example, browser 510, a display may be provided listing experts or expert servers. A user may search for an expert or expert server from this listing. Network 502 may contact expert web server 512 or expert web server 514. Alternatively, network 502 may contact both expert web server 512 and expert web server 514. Once this contact is made, a connection is made through network 502 to connect, for example, expert web servers 512 and/or 514 to client 508. Expert web servers 512 and/or 514 may contact client 508 directly. The communication between expert web servers 512 and/or 514 and client 508, may be, for example, electronic mail, an instant messaging service system, voice or web enabled phone communications, and the like.

Once expert web servers 512 and/or 514 and client 508 are communicating with each other, expert web servers 512 and/or 514 may receive more detail as to the information that client 508 is searching for. For example, the area of expertise that client 508 requests from expert web servers 512 or 514 may be in the area of electronic memory chips. Network 502 may search for available experts in the area of electronic memory chips. However, when expert web servers 512 and/or 514 and client 508 are actually communicating with each other, client 508 may narrow the search down to, for example, electronic memory chips which perform at a specified speed. By narrowing down the search in this manner, expert web servers 512 and/or 514 may more easily pinpoint the exact information client 508 wants.

Expert web servers 512 and/or 514 may then access web servers 504 and/or 506 to find the information client 508 has requested. With the knowledge that live expert 516 at expert web server 512 and/or live experts 518 and 520 at expert web server 514 possess, expert web servers 512 and/or 514 have the ability to go directly to the requested information without also including irrelevant information. Once expert web servers 512 and/or 514 have found the appropriate information located, for example, on a web site on web servers 504 and/or 506, the web site link(s) is/are sent to client 508. Expert web servers 512 and/or 514 and client 508 may simultaneously access the web site. The display of the web site is simultaneously displayed to both a user at client 508 and live expert 516 located at expert server 512 and/or live experts 518 and 520 located at expert web server 514. During this interactive cooperation between client 508 and expert web servers 512 and/or 514, the systems remain in constant communication with each other.

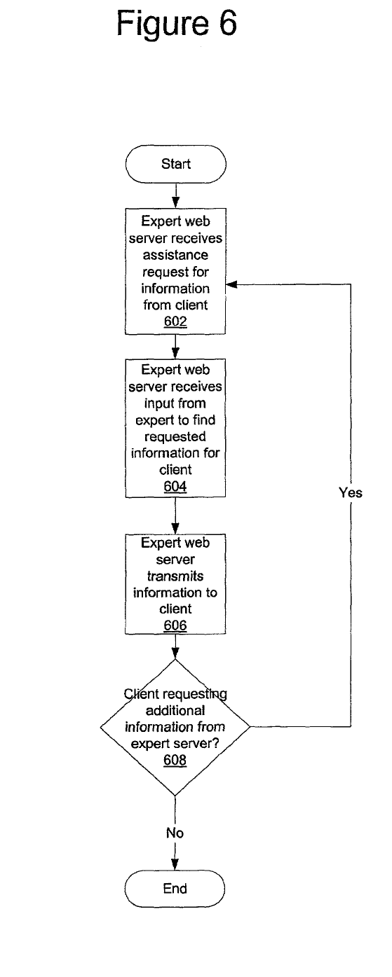

FIG. 6 is an exemplary flowchart illustrating an expert web server providing a means for the client accessing desired information on the network in accordance with a preferred embodiment of the present invention. In this example, the operation starts by the expert web server receiving an assistance request for information from the client (step 602). The expert web server then receives input from an expert at the expert web server to find the requested information for the client (step 604). The expert web server then transmits the information to the client (step 606). Then a determination is made as to whether or not the client is requesting additional information from the expert web server (step 608). If the client is not requesting additional information from the expert web server (step 608:NO), the operation terminates. If the client is requesting additional information from the expert web server (step 608:YES), the operation returns to step 602 in which the expert web server receives an assistance request from the client.

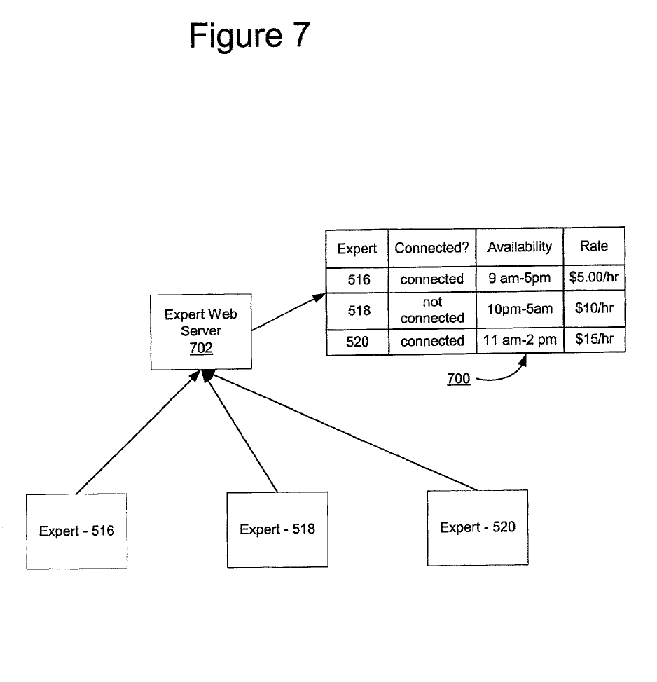

FIG. 7 is an exemplary expert availability database in accordance with a preferred embodiment of the present invention. The particular field and organization shown in FIG. 7 is for illustrative purposes only and any other fields or organizations may be used in addition to or in replacement of those shown in FIG. 7 without departing from the spirit and scope of the present invention.

In this example, once assistance is requested from a client, an expert web server, for example expert web server 702 may access database 700. Database 700 may contain information regarding characteristics of experts, such as, for example, experts 516, 518 and 520 in FIG. 5 which may include an identification of the expert, whether the expert is currently connected at the present time and is available for assisting in a search for information, the scheduled availability of the expert and the rate the expert expects in exchange for providing the expert assistance. In this example, expert 516 is currently connected, is available between the hours of 9 a.m. to 5 p.m. to provide expert assistance and expects to receive $5.00 per hour in exchange for providing expert assistance. In addition, database 700 indicates that expert 518 is not currently connected and is unavailable to assist a client in a search for information over the Internet. Therefore, if the client requests assistance in a search for information over the Internet at 1:00 p.m. and database 700 reflects the current status of experts 516, 518 and 520 at 1:00 p.m., experts 516 and 520 may be available to assist the client in the search for the information over the Internet.

Therefore, experts located at expert web servers may register with a server and provide assistance to clients on an as needed basis and earn extra income. The experts located at the expert web servers may provide characteristics and these characteristics may be stored in a database, such as database 700. As illustrated by database 700, the schedule of the experts may be flexible. The expert schedules may reflect the amount of available time the expert has to devote to providing expert assistance to a client in locating information over the Internet.

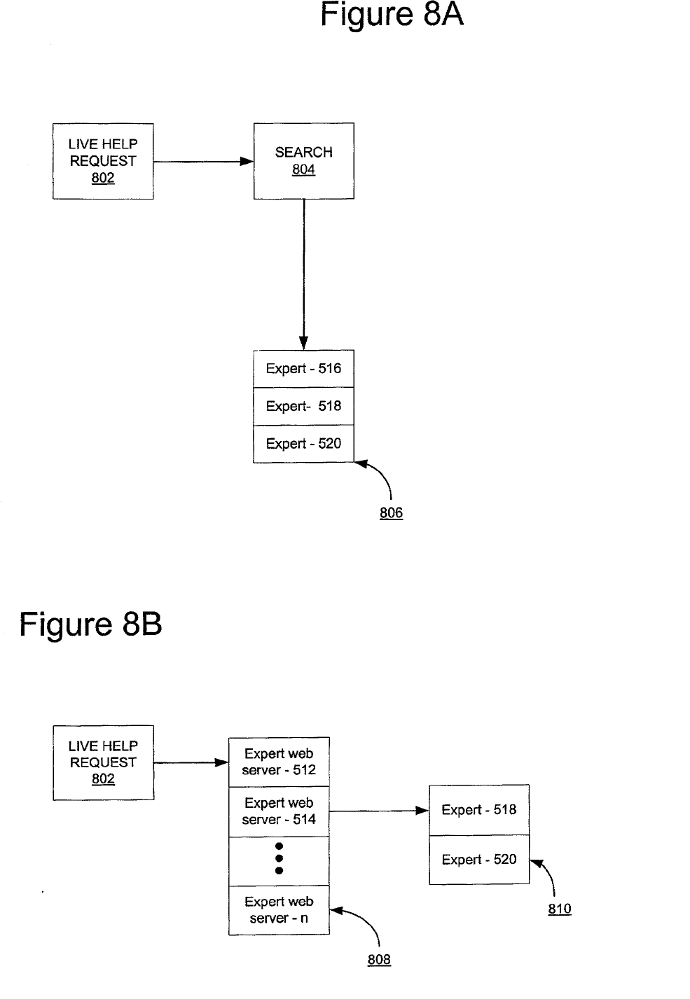

FIGS. 8A and 8B are an exemplary client selection processes for selecting an expert in accordance with a preferred embodiment of the present invention. FIG. 8A illustrates one method of selecting an expert by a client. In response to live help request 802, search 804 may be performed regarding a subject matter in which the client is interested. The client may input the subject matter, for example, “memory chips” and expert list 806 may be displayed after searching available experts and matching the available experts with the input subject matter or “memory chips.” In this example, expert list 806 contains entries for experts 516, 518 and 520 which, in this example, all have expertise in the field of “memory chips.” The client may choose any one of experts 516, 518, and 520 to receive information regarding experts 516, 518, and 520. The information regarding experts 516, 518, and 520, may be, for example, identification of the expert, whether the expert is currently connected and available for assisting a client in searching for information, hours of availability and rates for providing the assistance as illustrated in database 700 in FIG. 7. Once an expert is chosen, the client may then connect to the chosen expert's web server.

FIG. 8B illustrates an alternate method of selecting an expert by a client. In response to live help request 802, expert web server list 808 may be displayed which may include all expert web servers which have experts in the field of, for example, “memory chips.” The client may choose one expert web server, for example expert web server 514 and the experts associated with chosen expert web server 514 may be displayed in expert list 810. In this example, experts 518 and 520 are associated with expert web server 514. From expert list 810, the client may choose either expert 518 or expert 520. Alternatively, the client may choose both expert 518 and 520 to assist in the search for information over the Internet.

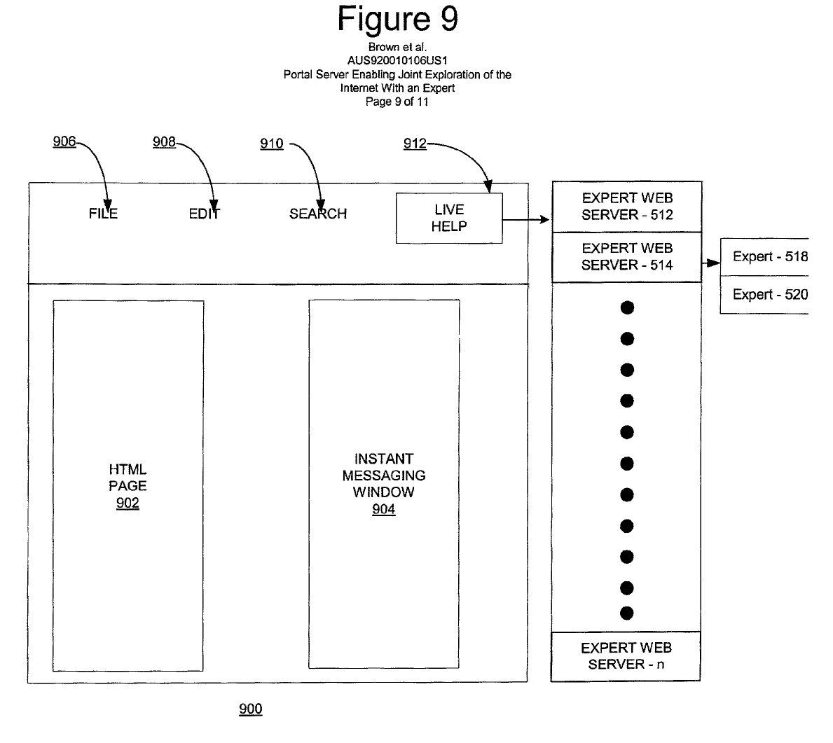

FIG. 9 is an exemplary graphical user interface for requesting and communicating with an expert in accordance with a preferred embodiment of the present invention. Graphical user interface 900 may be used by, for example, client 508 in FIG. 5 to request the help of an expert as well as communicate with an expert.

In this example, graphical user interface 900 contains HTML page display 902 and instant messaging service window 904. HTML page display 902 and instant messaging service window 904 are used for communication between a client, such as client 508 and an expert web server, such as, for example, expert web server 514 in FIG. 5. Graphical user interface 900 also contains file 906, edit 908, search 910 and live help button 912. The selection of live help button 912 by a user will activate the process of searching for an expert to help with the gathering of information by the user. If live help button 912 is, for example, “clicked” upon, a list of experts, for example, expert web servers 512-n, may be queried to determine if these experts possess the expertise to aid in the search of the information requested by a user. For example, expert web servers 512 and/or 514 may be queried to determine if any of the expert web servers 512 and/or 514 includes an expert in the field of, for example, electronic memory chips. Alternatively, a client may select expert web servers 512 and/or 514 directly and then may select and expert within web servers 512 and/or 514 which are experts in the field of electronic memory chips.

If any of expert web servers 512 and/or 514 includes an expert in the field of electronic memory chips, then the availability of experts associated with the expert web servers in this field is determined. For example, assume expert web servers 512 and 514 includes experts in the field of electronic memory chips. However, expert web server 512 is currently unavailable to help the user. Therefore, expert web server 514 is chosen to assist in the search for information regarding electronic memory chips. In response to the selection of expert web server 514, experts 518 and 520 may be displayed. The client may choose either expert 518 or 520. Alternatively, the client may choose both expert 518 and 520 to assist in the search for information over the Internet.

Expert web server 514 may contact the user using instant messaging service window 904. The user and expert web server 514 may continue communicating throughout the search for the information. When expert web server 514 finds, for example, an appropriate web page containing the information requested by the user, expert web server 514 may send the web page link which will be displayed on HTML page 902. The user may access the web page via the web page link and the web page will be displayed on HTML page 902.

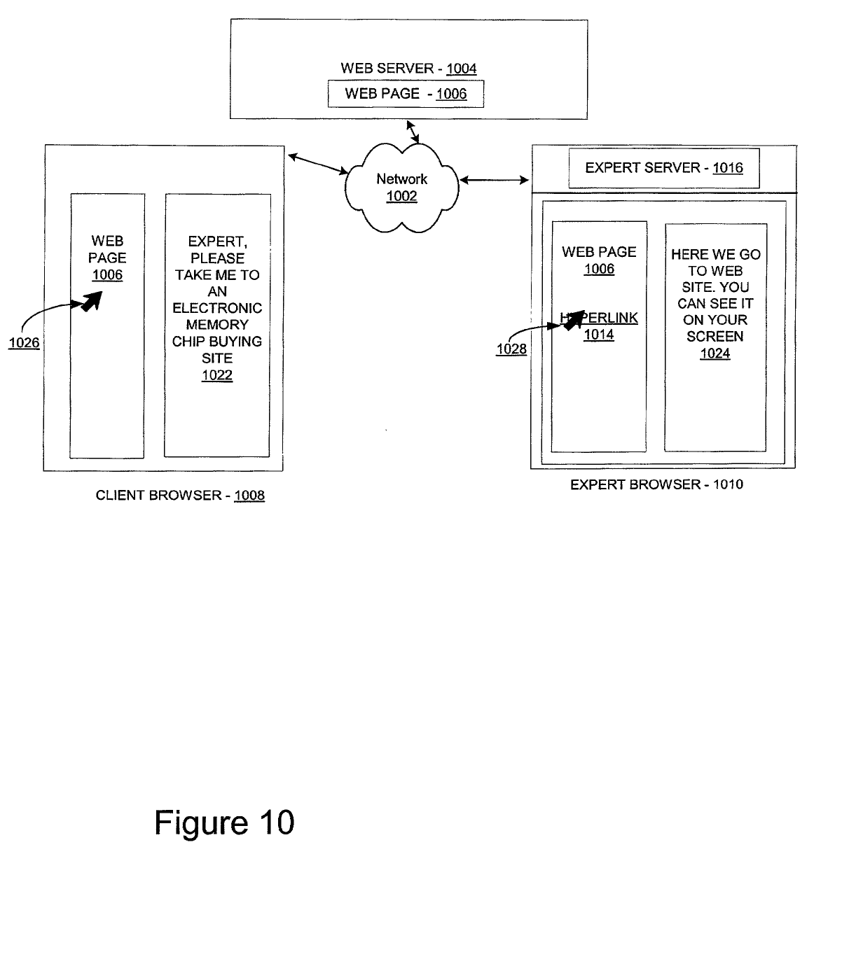

FIG. 10 is an exemplary client browser and expert browser for simultaneously accessing a web page in accordance with a preferred embodiment of the present invention. The client and expert may simultaneously navigate the Internet with similar displays on their respective display devices. Once expert web server 512 in FIG. 6 accesses web page hyperlink 1014 by, for example, clicking on hyperlink 1014 using cursor 1028, web server 1004, which contains web page 1006, will send web page 1006 to network 1002. Network 1002 will distribute web page 1006 to both client browser 1008 and expert browser 1010 or the client browser may receive web page 1006 via the expert. Web page 1006 will be sent to expert browser via expert server 1016. If an expert located at expert server 1016 selects hyperlink 1014, then both the user and the expert access web page 1006 associated with hyperlink 1014. Web page 1006 will then be displayed on client browser 1008 as well as on expert browser 1010. Communication is maintained between the user by using, for example, instant messaging service 1022 located on client browser 1008 and instant messaging service 1024 located on expert browser 1024. Once web page 1006 is displayed upon client browser 1008, the user may choose specific items from web page 1006 by using client cursor 1026.

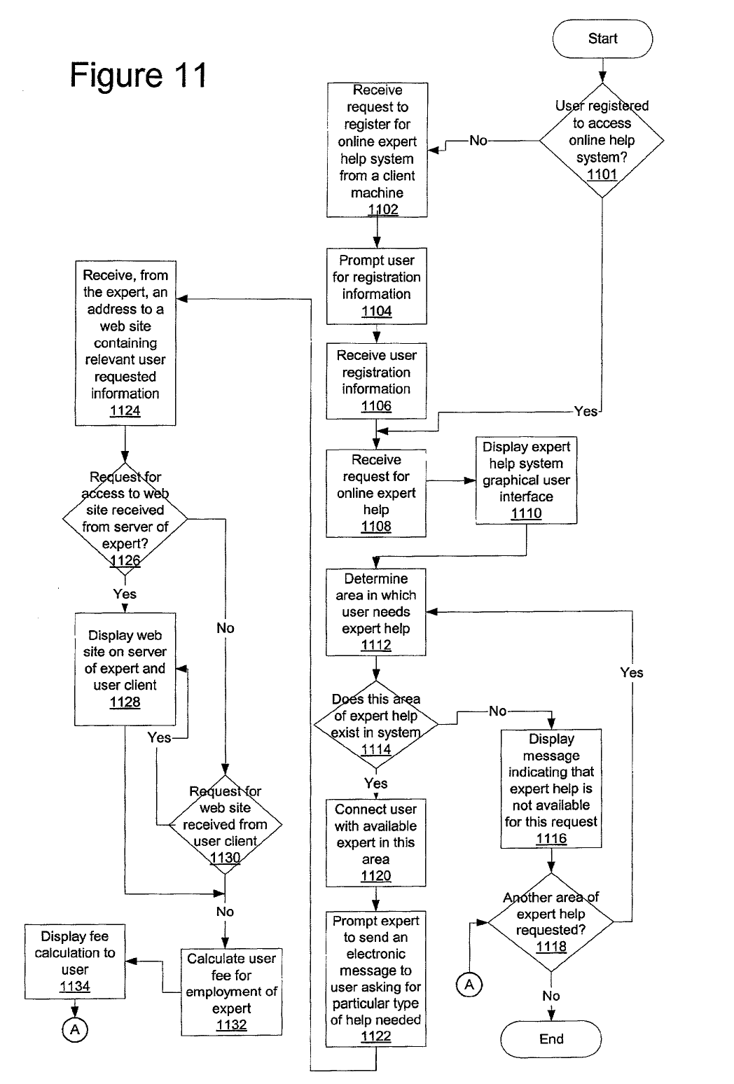

FIG. 11 is an exemplary flowchart for a portal server enabling joint exploration of the Internet between a user and an expert in accordance with a preferred embodiment of the present invention. In this example, the operation begins with a determination as to whether or not the user is registered to access the online help system (step 1101). If the user has an existing registration to access the online help system (step 1101:YES), then the operation continues to step 1108 in which a request for online expert help is received. If the user is not registered to access the online help system (step 1101:NO), then a request is received to register for an online expert help system from a client machine (step 1102). A prompt is then made for user information (step 1104). The prompt for user information may include, for example, information about the user requesting the assistance of an expert. The user information may include, for example, credit card information for payment purposes, personal information such as name and address, areas of interest in which to request the assistance of an expert, and the like. The user registration information is received (step 1106) and then a request is received for online expert help (step 1108). Then an expert help system graphical user interface is displayed (step 1110). The graphical user interface may be, for example, similar to graphical user interface 600 in FIG. 6. A determination is then made as to which area the user needs online help (step 1112). Then a determination is made as to whether or not this area of expert help exists within the online expert help system (step 1114). If this area of expert help does not exist in the online expert help system (step 1114:NO), then a message is displayed indicating that this area of expert help is not available for this request (step 1116). Then a determination is made as to whether or not another area of online expert is requested (step 1118). If another area of online expert help is requested (step 1118:YES), then the operation returns to step 1112 to determine which area a user needs online expert help. If another area of online expert help is not requested (step 1118:NO), the operation terminates.

Returning to step 1114, if it is determined that the area of help requested by the user is available on the online expert system (step 1114:YES), then the user is connected to an available expert in the area requested by the user (step 1120). Then a prompt is displayed to the expert requesting that the expert send an electronic message to the user asking the user for the particular type of expert help needed (step 1122). The electronic message may be by, for example, electronic mail or an instant messaging service. Then an address is received from the expert for a web site containing relevant user requested information (step 1124). Alternatively, an expert may use an Internet search engine. A determination is then made as to whether or not a request for access to the web site is received from a server of the expert (step 1126). If the request for access to the web site is received from a server of the expert (step 1126:YES), the web site is displayed on the server of the expert and the client of the user (step 1128). If the request for access to the web site is not received from a server of the expert (step 1126:NO), then a determination is made as to whether or not the request for access to the web site is received from the client of the user (step 1130). If the request for access to the web site is received from the client of the user (step 1130:YES), the web server site is displayed to both the server of the expert and client of the user (step 1128).

If the request for access to the web site is not received from the client of the user (step 1130:NO) or after displaying the web site on both the server of the expert and the client of the user (step 1128), the operation continues by calculating a fee for employment of the expert by the user (step 1132). The fee is displayed to the user (step 1134) and the operation returns to step 1118 in which a determination is made as to whether or not another area of expert help is requested.

Therefore, the present invention provides a mechanism by which a user can search the Internet employing the aid of an expert. With the vast amount of information available on the Internet, the present invention provides a mechanism by which a user may more easily and in a more timely manner find the exact information relevant to the user's search. In conjunction with an expert in an area applicable to the user's interest, only that information which the user specifically desires can be found in an efficient matter without the undue waste of the user's valuable time.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communication links, wired or wireless communication links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for obtaining assistance in a search for information, on a data processing system, the information concerning a subject area, the method comprising the steps of:
requesting an interactive expertise session, wherein the request for the interactive expertise session is received from a live help selection option located on a browser graphical user interface;
responsive to the request for the interactive expertise session, receiving an electronic page related to the subject area and a communication interface; and
displaying generated interactive expertise, wherein the generated interactive expertise is simultaneously displayed upon both the communication interface and the electronic page.

2. The method as recited in claim 1, wherein the generated interactive expertise displayed upon the communication interface is a communication between a requester of the interactive expertise and a supplier of the interactive expertise.

3. The method as recited in claim 2, wherein the communication between a requester of the interactive expertise and a supplier of the interactive expertise is at least one of an electronic mail message and an instant messenger message service.

4. The method as recited in claim 2, wherein the communication between the requester of the expertise and the supplier of the expertise is at least one of textual communication and audible communication.

5. The method as recited in claim 1, wherein the request for the interactive expertise is from a client machine.

6. The method as recited in claim 1, wherein generation of the interactive expertise is from a server.

7. The method as recited in claim 6, wherein the server is an expert web server.

8. The method as recited in claim 1, wherein simultaneously providing a communication interface and a electronic page display is provided on the graphical user interface.

9. The method as recited in claim 1, wherein the generated interactive expertise displayed upon the electronic page display is transmitted from a generator of the interactive expertise.

10. The method as recited in claim 1, further comprising:
upon termination of the interactive expertise session, calculating a charge for the interactive expertise session; and
displaying the charge to the requester of the interactive expertise session.

11. The method as recited in claim 10, wherein the requester of the expertise session is charged for the expertise on a predetermined basis which includes at least one of a flat fee basis, a time basis and a commission basis.

12. The method as recited in claim 1, further comprising:
matching a requested area of expertise within an area of a supplier of the expertise; and
generating the expertise based on results of the matching.

13. The method as recited in claim 12, wherein matching a requested area of expertise within an area of the supplier of the expertise is matched to a plurality of suppliers of the expertise.

14. The method as recited in claim 13, further comprising:
determining which of the plurality of suppliers of the expertise is available; and
connecting an available supplier of the expertise to the requester of the expertise.

15. The method as recited in claim 1, wherein the electronic page display is at least one Internet web page.

16. The method as recited in claim 1, wherein the generated expertise is generated using a Internet search engine.

17. A method for assisting in a search for information, on a data processing system, the method comprising the steps of:
responsive to receiving a request for an interactive expertise session, from a live help selection option located on a browser graphical user interface, concerning a subject area, selecting a first electronic page having a content from a plurality of electronic pages, wherein the content is associated with the subject area;
responsive to receiving the first electronic page, simultaneously displaying the first electronic page and a communication interface; and
transmitting generated interactive expertise based on the subject area, wherein the generated interactive expertise utilizes both the first electronic page and the communication interface.

18. The method as recited in claim 17, wherein the request for the interactive expertise is from a client machine.

19. The method as recited in claim 17, wherein the interactive expertise is generated from a server.

20. The method as recited in claim 19, wherein the server is an expert web server.

21. The method as recited in claim 17, further comprising:
selecting a second electronic page having a content from the plurality of electronic pages;
replacing the first electronic page with the second electronic page;
simultaneously displaying the second electronic page and the communication interface; and
transmitting generated interactive expertise based on the subject area, wherein the generated interactive expertise utilizes both the second electronic page and the communication interface.

22. A method for assigning an expert in a search for information on a data processing system, the method comprising the steps of:
registering an expert with a web server on the data processing system;
providing characteristics of the registered expert, wherein the characteristics of the registered expert are stored in a database; and
locating the registered expert to provide assistance in the search for information based on the stored characteristics.

23. A data processing system, comprising:
a bus system;
a communication unit connected to the bus system;
a memory connected to the bus system, wherein the memory includes a set of instructions;
an output unit connected to the bus system; and
a processing unit connected to the bus system, wherein the processing unit executes the set of instructions from the memory to request an interactive expertise session, and wherein the request for the interactive expertise session is received from a live help selection option located on a browser graphical user interface, responsive to the request for the interactive expertise session, the processing unit receives via the communication unit an electronic page related to a subject area and a communication interface, and the processing unit instructs the output unit to display generated interactive expertise, wherein the generated interactive expertise is simultaneously displayed upon both the communication interface and the electronic page.

24. A data processing system, comprising:
a bus system;
a communication unit connected to the bus system;
a memory connected to the bus system, wherein the memory includes a set of instructions;
an output unit connected to the bus system; and
a processing unit connected to the bus system, wherein, responsive to receiving a request for an interactive expertise session, from a live help selection option located on a browser graphical user interface, concerning a subject area, the processing unit executes the set of instructions from the memory to select a first electronic page having a content from a plurality of electronic pages, wherein the content is associated with the subject area, responsive to receiving the first electronic page, the processing unit instructs the output unit to simultaneously display the first electronic page and a communication interface, and the processing unit instructs the communication unit to transmit generated interactive expertise based on the subject area, wherein the generated interactive expertise utilizes both the first electronic page and the communication interface.

25. A data processing system, comprising:
a bus system;
a memory connected to the bus system, wherein the memory includes a set of instructions;
a storage unit connected to the bus system;
an input device connected to the bus system; and
a processing unit connected to the bus system wherein the processing unit executes the set of instructions from the memory to register an expert with a web server on a data processing system, the processing unit receives characteristics of the registered expert are provided via the input device, wherein the processing unit instructs the storage unit to store the characteristics of the registered expert in a database, and the processing unit locates the registered expert to provide assistance in the search for information based on the stored characteristics.

26. A system for obtaining assistance in a search for information, on a data processing system, the information concerning a subject area, comprising:
requesting means for requesting an interactive expertise session, wherein the request for the interactive expertise session is received from a live help selection option located on a browser graphical user interface;
receiving means, responsive to the request for the interactive expertise session, for receiving an electronic page related to the subject area and a communication interface; and
displaying means for displaying generated interactive expertise, wherein the generated interactive expertise is simultaneously displayed upon both the communication interface and the electronic page display.

27. The system as recited in claim 26, further comprising:
calculating means, upon termination of the interactive expertise session, for calculating a charge for the interactive expertise session; and
displaying means for displaying the charge to the requester of the interactive expertise session.

28. The system as recited in claim 26, further comprising:
matching means for matching a requested area of expertise within an area of a supplier of the expertise; and
generating means for generating the expertise based on results of the matching.

29. A system for assisting in a search for information, on a data processing system, comprising:
selecting means, responsive to receiving a request for an interactive expertise session concerning a subject area, for selecting a first electronic page having a content from a plurality of electronic pages, wherein the content is associated with the subject area;
displaying means, responsive to receiving the first electronic page, for simultaneously displaying the first electronic page and a communication interface; and
transmitting means for transmitting generated interactive expertise based on the subject area, wherein the generated interactive expertise utilizes both the first electronic page and the communication interface.

30. The system as recited in claim 29, further comprising:
selecting means for selecting a second electronic page having a content from the plurality of electronic pages;
replacing means for replacing the first electronic page with the second electronic page;
displaying means for simultaneously displaying the second electronic page and the communication interface; and
transmitting means for transmitting generated interactive expertise based on the subject area, wherein the generated interactive expertise utilizes both the second electronic page and the communication interface.

31. A system for assigning an expert for assisting in a search for information, on a data processing system, comprising:
registering means for registering the expert with a web server on the data processing system;
providing means for providing characteristics of the registered expert, wherein the characteristics of the registered expert are stored in a database; and
locating means for locating the registered expert to provide assistance in the search for information based on the stored characteristics.

32. A computer program product in a computer readable medium for obtaining assistance in a search for information, on a data processing system, the information concerning a subject area, comprising:
instructions for requesting an interactive expertise session, wherein the request for the interactive expertise session is received from a live help selection option located on a browser graphical user interface;
instructions, responsive to the request for the interactive expertise session, for receiving an electronic page related to the subject area and a communication interface; and
instructions for displaying generated interactive expertise, wherein the generated interactive expertise is simultaneously displayed upon both the communication interface and the electronic page.

33. The computer program product as recited in claim 32, further comprising:
instructions, upon termination of the interactive expertise session, for calculating a charge for the interactive expertise session; and
instructions for displaying the charge to the requester of the interactive expertise session.

34. The computer program product as recited in claim 32, further comprising:
instructions for matching a requested area of expertise within an area of a supplier of the expertise; and
instructions for generating the expertise based on results of the matching.

35. A computer program product in a computer readable medium for assisting in a search for information, on a data processing system, comprising:
instructions, responsive to receiving a request for an interactive expertise session, from a live help selection option located on a browser graphical user interface, concerning a subject area, for selecting a first electronic page having a content from a plurality of electronic pages, wherein the content is associated with the subject area;
instructions, responsive to receiving the first electronic page, for simultaneously displaying the first electronic page and a communication interface; and
instructions for transmitting generated interactive expertise based on the subject area, wherein the generated interactive expertise utilizes both the first electronic page and the communication interface.

36. The computer program product as recited in claim 35, further comprising:
instructions for selecting a second electronic page having a content from the plurality of electronic pages;
instructions for replacing the first electronic page with the second electronic page;
instructions for simultaneously displaying the second electronic page and the communication interface; and
instructions for transmitting generated interactive expertise based on the subject area, wherein the generated interactive expertise utilizes both the second electronic page and the communication interface.

37. A computer program product for assigning an expert for assisting in a search for information, on a data processing system, comprising:
instructions for registering the expert with a web server on the data processing system;
instructions for providing characteristics of the registered expert, wherein the characteristics of the registered expert are stored in a database; and
instructions for locating the registered expert to provide assistance in the search for information based on the stored characteristics.
